(19) United States
(12) Patent Application Publication
(10) Pub. No.: US 2010/0276997 A1
(43) Pub. Date: Nov. 4, 2010

(54) INTELLIGENT INDUSTRIALIZED ELECTRICAL SYSTEM THAT CAN BE CUSTOMIZED FOR PREMISES

(75) Inventors: Jean-Marie GOMEZ, Lauzerville (FR); Philippe NOBILE, Pins Justaret (FR)

Correspondence Address: YOUNG & THOMPSON, 209 Madison Street, Suite 500, Alexandria, VA, 22314, US

(73) Assignee: M.I.P. SARL, Soreze (FR)

(21) Appl. No.: 12/433,057

(22) Filed: Apr. 30, 2009

(51) Int. Cl. H02J 3/00

(52) U.S. Cl. 307/38

(57) ABSTRACT

A system designed to equip premises provided with an electric meter and a general breaker includes:—a stationary reception station, a box irremovably attached to the station,—a unit for protection against overloads, mounted in the box, designed to be connected to the breaker by connectors of the reception station and of the box and designed to be connected via connectors of the box, and of the reception station, to the electrical installation 1 of the premises,—at least one sensor suitable for providing signals representative of physical quantities,—at least one unit for equipment management installed in the box, suitable for receiving, via the connectors of the reception station and of the box, the electrical signals from each sensor and for controlling in return—via the connectors of the box and of the reception station—at least one electrical apparatus.

This invention relates to an intelligent industrialized electrical system that can be customized for premises of all applications that integrate especially home automation functions. It applies especially to management of home automation equipment of premises that can be of the habitable type and can be occupied by able-bodied or disabled individuals, without being limited thereto.

Nowadays, to cope with the handicaps of users, it is necessary to have them change premises, to direct them to better suited premises (group home or rehabilitation home), or to promote keeping handicapped individuals at home by modifying their housing, i.e., adapting it to their handicap.

While the usage of power and electrical signals has become ubiquitous, the principles of installation and use of electrical equipment that is very small-scale have developed little. At the base of an electrical installation, there are the juxtaposition and connection of a large number of elements installed on a small scale.

There are increasingly more home automation applications based on computer programs that guarantee their operation. The elevated installation costs of these applications limit their popularity. Moreover, their installers must have great technical skill. Once installed on a small scale, current home automation applications are complex to use and maintain. They are heterogeneous, entail redundancy of functions, have little coherence, lack the capacity of communication and evolution among themselves as well as a capacity for evolution. This is due to the fact that there is no comprehensive standardized solution, but rather a variety of solutions.

Moreover, their maintenance can be difficult to support, especially due to their lack of standardization.

This invention is designed to alleviate these problems.

To do this, this invention calls for an intelligent industrialized electrical system that can be customized and that integrates home automation functions, characterized in that it comprises:

a reception station equipped with means for attachment to at least one inside surface of the premises, such as a wall, partition, ceiling and/or floor,

a box designed to be attached in a removable manner to the reception station,

a unit for protection against electrical overloads and protection of property and individuals, installed in the box, on the one hand designed to be electrically connected to a breaker via an electrical line and by working female electrical connectors of the reception station and male connectors of the box, and on the other hand designed to be connected via working female electrical connectors of the box and male connectors of the reception station to the electrical installation 1 of the premises,

at least one sensor suitable for providing signals representative of physical quantities,

at least one processing unit for equipment management installed in the box, suitable for receiving, via working female electrical connectors of the reception station and male connectors of the box, electrical signals originating from each said sensor and for controlling via working female electrical connectors of the box and male connectors of the reception station, depending on the signals provided by each said sensor, at least one electrical apparatus installed in said premises.

Optionally, the processing unit can be self-contained, i.e., external to the box and connected to the internal equipment via a connection and communication means.

According to another characteristic of the invention, the first connection means and/or the second connection means are working electrical connectors of the box and the reception station and the associated electrical lines.

Optionally, the aforementioned first and/or second connection means are of the radio frequency type.

Optionally, the first and/or second connection means between the system components are of the optical type.

Optionally, the communications means will be able to use the supply means of the various pieces of equipment by using the technology of on-line carrier currents.

Due to these arrangements, the reception station and the box of the intelligent system that is the object of this invention can be built at the factory and installed at the premises with all of the equipment that they comprise.

Installation, connection and management of the home automation equipment of the premises are thus simplified.

The high level of industrialization of the intelligent system that is the object of this invention allows a significant reduction of cost of the electrical installation at the premises.

The removability of the box makes to possible to keep current with technical evolution and maintenance and facilitates its replacement. The removability of the box is based on a standardized connector interface between the reception station and the box.

The removable box of the intelligent system merges the following:

connections,

electrical elements for protection of property and individuals,

hardware interfaces of sensor acquisition and of equipment control,

a data processing unit.

Mounting and installation of home automation applications are thus facilitated and the system can evolve depending on the needs of the users and development of technology.

Industrialization of the system that is the object of this invention yields especially the following advantages:

operating reliability,

greater efficiency and standardization of the industrialized equipment,

reduction of costs of production, installation, repair and maintenance,

installation and replacement within very short intervals,

capacity to evolve both in terms of functions according to user needs and operating and physical adaptability to the usage of the premises.

Moreover, the intelligent system that is the object of this invention allows development of services to meet needs and expectations in the following areas:

sanitation,

nutrition,

comfort,

safety,

communication,

social interaction,

on-line services.

According to another characteristic of the invention, the reception station comprises a first compartment designed to hold the box in a removable manner and a second compartment adjoining the preceding allotted to the connecting wiring of the electrical and optical lines of the premises by means of electrical and/or optical connectors, said compartments being separated from one another by at least one partition.

The high current and low current connections that the second compartment comprises will be separated from one another according to the standards in force.

According to another characteristic of the invention, the connector or connectors of the reception station is or are attached to the separating wall, said connectors being designed to work with the equivalent connectors of the box, these connectors being able to be moved or affixed to one of the walls.

Optionally, according to another characteristic of the invention, the connector or connectors of the box are affixed to one of the walls of the latter, and the equivalent connectors of the reception station are movable.

According to still another variant embodiment, the connector or connectors of the reception station and the connector or connectors of the box are of the movable type.

According to another characteristic of the invention, the reception station in the first compartment comprises means of positioning and means of immobilization of the box, said box comprising positioning means designed to work by form-fitting with the positioning means that the first compartment comprises.

According to particular characteristics, the intelligent system that is the object of this invention comprises at least one communications bus to which the equipment installed in the premises is connected.

Due to these arrangements, the processing unit can easily communicate with each of the pieces of equipment connected to the bus.

According to particular characteristics, the intelligent system that is the object of this invention comprises a long-distance communications means on a computer network. For example, the system that is the object of this invention allows access to the web and/or an electronic bulletin board and/or services that can be allocated to maintenance of the individuals at home, etc.

According to particular characteristics, the intelligent system that is the object of this invention comprises a means of detection and warning of an abnormal situation that can be an imminent danger, this means being managed by the processing unit. For example, this detection means can detect an incipient fire by analysis of infrared radiation and/or by analysis of the level of harmful gas present in the premises, an escape of gas by analysis of the atmosphere of the premises, a breaking and entering attempt, etc. The processing unit in return will be able to activate an acoustic or light alarm installed inside or outside the premises. An alarm will be able to be transmitted to an outside rescue service.

Due to these arrangements, the occupants of the premises can be warned of an imminent danger in time.

According to particular characteristics, the intelligent system that is the object of this invention comprises a means of control of openings managed by said processing unit. Due to these arrangements, electric shutters, electric curtains and/or electric awnings can be automatically actuated by the system.

According to particular characteristics, the intelligent system that is the object of this invention comprises a means of controlling equipment of social interaction, for example audio-visual and/or multimedia equipment. Due to these arrangements, each user can have access and can control means of broadcast of audiovisual programs and multimedia works.

According to particular characteristics, the intelligent system that is the object of this invention comprises at least one camera for purposes of long-distance surveillance of the premises and the individuals located there, thus promoting keeping individuals at home. It will be possible to be equipped with at least one camera for surveillance of the exterior of the premises.

According to particular characteristics, the intelligent system according to the invention comprises at least one sensor for measuring ambient parameters within the home, for example a humidity sensor, a temperature sensor, a light level sensor, etc., in order to optimize the energy budget of the home and to improve the well-being of the occupants.

According to particular characteristics, the processing unit of the intelligent system is suited to implementing at least one user profile to control at least one electrical apparatus installed in said premises depending on the preferences of the user.

According to particular characteristics, the processing unit makes it possible to store on a removable medium the personal parameters of the users for purposes of their safeguarding and transfer to other premises equipped with the same intelligent system.

The intelligent system that is the object of this invention makes it possible to keep dependent individuals at home by facilitating access to services in the areas of communications, safety of the premises (for property and individuals) in the areas of quality of life. By easy access to on-line services, dependent individuals will be easily able, in relation to care services, for example, to request visitation of an individual able to provide this care. By these services, they will also be able to have access to any other type of site, for example sales sites for products necessary for daily living, especially food products, by home delivery.

Other advantages, objectives and characteristics of the intelligent system that is the object of this invention will become apparent from the following description that is explanatory and in no way restrictive with respect to the attached drawings in which:

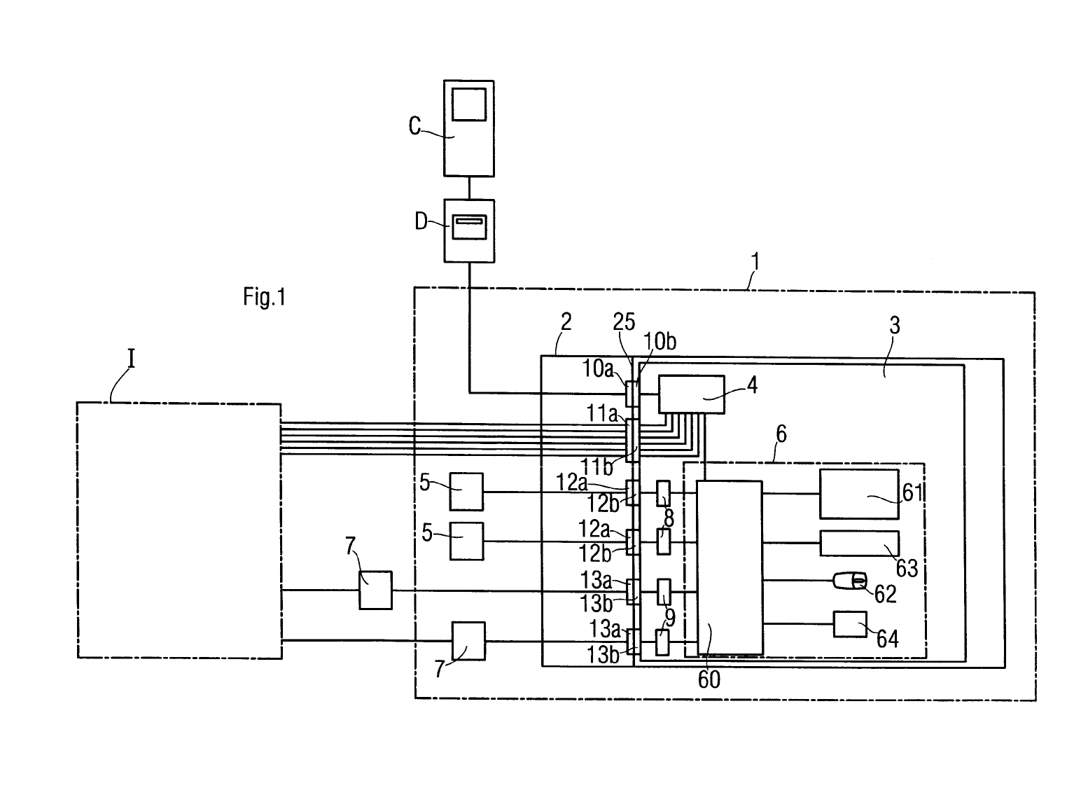

FIG. 1 schematically shows premises and an intelligent system according to this invention,

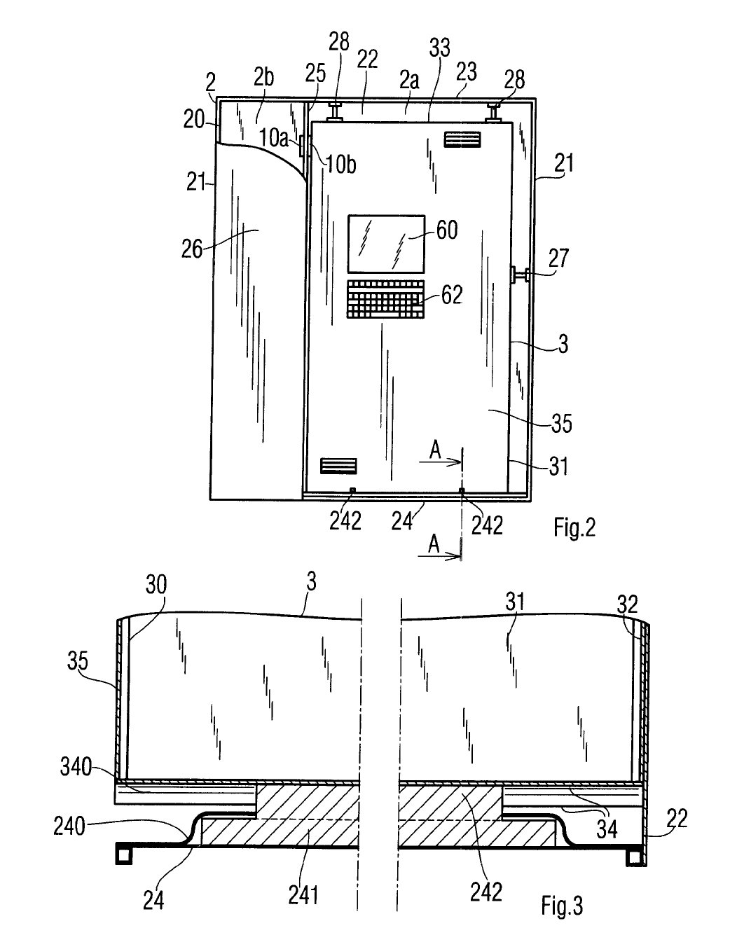

FIG. 2 is a front view of a reception station and a box mounted in the latter,

FIG. 3 is a partial cutaway view along line AA of FIG. 2,

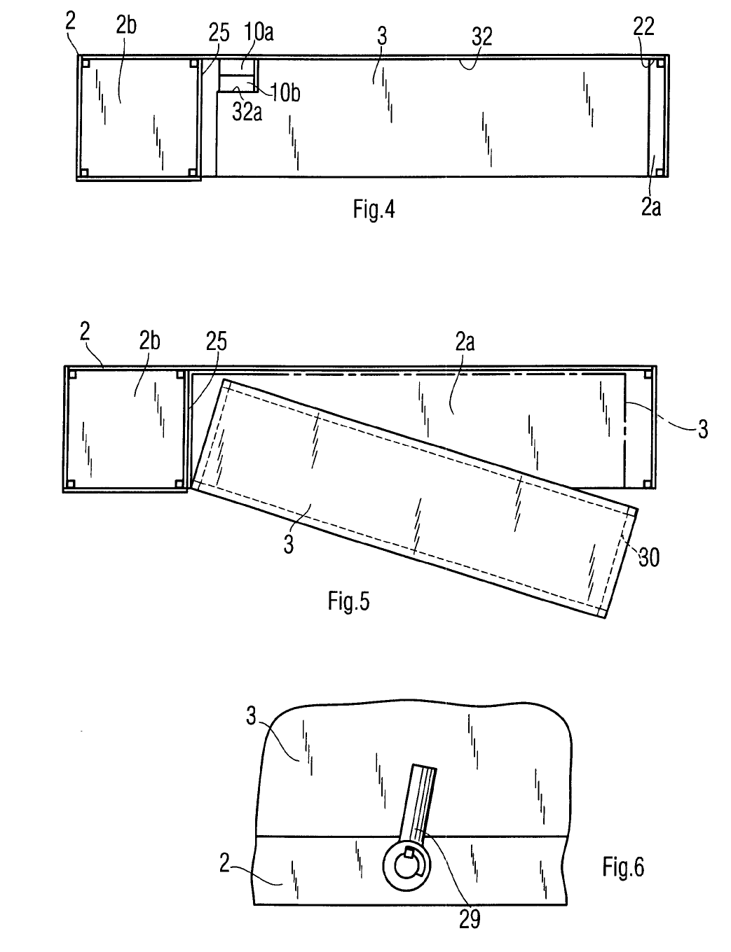

FIG. 4 is a partial cutaway view showing a second embodiment of the reception station and the box of the system according to the invention, mounted in a wall light against a wall,

FIG. 5 is a partial cutaway view showing a third embodiment of the reception station and the box of the system according to the invention, mounted in a wall light against a wall,

FIG. 6 shows a lock designed to immobilize the box in the reception station.

FIG. 1 shows premises equipped with an electric meter C connected to the electric power distribution network and linked to a general electric breaker D. The industrialized intelligent electrical system 1 that is the object of this invention is installed on the premises.

This intelligent system 1 comprises:

a reception station 2 comprising means of attachment to at least one interior surface of the premises, such as a wall, partition, floor and/or ceiling,

a box 3 designed to be attached in a removable manner to the reception station,

a unit 4 for protection against electrical overloads and protection of property and individuals, installed in the box 3, on the one hand designed to be electrically connected to a breaker D via an electrical line and by working female electrical connectors 10a of the reception station 2 and male connectors 10b of the box 3, and on the other hand designed to be connected via working female electrical connectors 11b of the box 3 and male connectors 11a of the reception station 2 to the electrical installation 1 of the premises,

at least one sensor 5 suitable for providing signals representative of physical quantities that it acquires,

at least one processing unit 6 for equipment management installed in the box 3, suitable for receiving, via working female electrical connectors 12a of the reception station 2 and male connectors 12b of the box 3, electrical signals originating from each said sensor 5 and for controlling via working female electrical connectors 13b of the box 3 and male connectors 13a of the reception station 2, depending on the signals provided by each said sensor, at least one electrical apparatus 7 installed in said premises.

The reception station 2 is installed permanently on the premises. It is anchored in a wall, a partition, the floor and/or the ceiling of the premises. This station 2, installed permanently on the premises, has two functions: one—mechanical—for comprising the mechanical interface for guiding and attaching the box 3, and the other—electrical—for ensuring the connections of electrical equipment housed in the box with the electrical networks and systems external to the box. This reception station 2 is installed during a building phase or renovation phase of the premises in order to accommodate the box of the intelligent system that is the object of this invention.

Advantageously, it can act as the framing element for building walls and partitions.

The general breaker D will be able to be mounted in the reception station 2 and more specifically in the compartment 2b.

According to one preferred embodiment, the reception station 2 comprises a bearing framework 20 formed by the assembly of metal profiles that define a rectangular parallelepiped volume. Metal walls that form two lateral vertical sides 21, one rear vertical side 22, one upper horizontal side 23, and one lower horizontal side 24 are attached to this framework by riveting or other fastening means.

The reception station 2 will be able to be attached, with the capacity to be dismounted, using screws and dowels to the floor and/or corresponding wall of the premises.

In addition, the reception station 2, in its internal volume, comprises a separating wall 25 extending perpendicular to the rear side 22. This separating wall 25 divides the internal volume into two compartments 2a, 2b, the first 2a of which is designed to accommodate the box 3 and the other 2b comprises the access to different electrical connectors held by the separating wall 25 as well as to the electric cable entries of the electrical installation of the premises in order to implement electrical connections. This compartment 2b is closed by a removable protective wall 26 that prevents access to the wiring.

The separating wall 25 is preferably vertical, and in this case, the second compartment 2b occupies a position that is lateral relative to the first. Optionally, the separating wall 25 is horizontal, and the second compartment 2b preferably occupies an upper position relative to the first compartment 2a. It will also be able to occupy a lower position.

In the case in which the reception station 2 is equipped with a general breaker D, it will preferably be mounted in the second compartment 2b.

The electrical connectors 10a, 11a, 12a, and 13a held by the vertical separating wall 25 are inserted into through holes that the latter comprises and are attached to the latter by any known means.

The box 3 of a preferably rectangular parallelepiped shape has a bearing framework 30 formed by assembly of profiles or any other suitable material. This framework 30 holds by attachment the walls of insulating material forming two lateral vertical walls 31, one rear vertical wall 32, one upper horizontal wall 33, one lower horizontal wall 34, and one front vertical wall 35.

The wall of the lateral walls 31 of the box 3 designed to be arranged opposite the separating wall 25 of the reception station 2 is equipped with male and female electrical connectors 10b, 11b, 12b, and 13b.

The first compartment 2a of the reception station 2, in the lower part, perpendicularly to the separating wall 25, comprises, attached to the lower side 24, a means for horizontal guidance, for example a rail 240, in which a horizontal plate 241 is mounted to be able to slide, designed for supporting the box 3 in the first compartment 2a.

The support plate 241 is equipped with means for positioning the box 3, composed of, for example, elongated bosses 242 designed to work by form-fitting with recesses 340 of complimentary shape arranged in the lower wall 34 of the box 3. Each elongated boss 242, by its longitudinal axis, extends perpendicular to the direction of movement of the support plate 241 in the rail 240.

The box 3 is inserted into the first compartment 2a by pushing toward the rear side 22 of the reception station and is guided during this motion by longitudinal bosses 242. It should be noted that this rear side 22 comprises a stop to the motion of insertion of the box 3 into the reception station 2.

The connection of the electrical connectors 10b, 11b, 12b, and 13b held by the box 3 to the electrical connectors 10a, 11a, 12a, and 13a held by the separating wall 25 is accomplished by moving the box 3 toward the separating wall 25 by sliding the plate 241 on its guide rail 240.

Optionally, the connectors 10a, 11a, 12a, and 13a are no longer attached to the separating wall 25, but are mounted to be able to move on their respective cables. The connection in this case is done manually.

To prevent unexpected disconnection of the box 3 by unintentional movement of the plate 241 on its rail 240, there will be at least one locking means 27. This locking means will be able to be composed of a retractable stop that is integral with the framework 20 of the reception station 2 and supported against the box 3 to ensure the locking function of the latter. This stop will be composed of, for example, a system of the screw and nut type. The nut of the system will be attached to, for example, the lateral vertical wall 31 of the reception station. The screw will comprise a support pad on the end designed to press against the box 3.

In addition, there will be means 28 for immobilizing the box 3 in its compartment 2a. These means will be able to be composed of screw jacks mounted on the upper horizontal wall of the box. The screw of each jack will be equipped with an end pad designed to be supported against the surface that is internal to the compartment 2a of the upper wall 33 of the box 3 by actuating the screw.

The front wall 35 of the box 3 can be completely or partially removable in order to be able to access the internal volume of the box, in particular to ensure maintenance of the electrical components installed there.

The framework 30 of the box 3 in the volume of the latter comprises supports of internal electrical and electronic equipment.

To allow dissipation of the heat generated by the electrical and electronic equipment installed in the box, at least one of the walls of the latter will be equipped with ventilation holes, upper and lower, in order that natural ventilation from bottom to top is established in the box. To enhance this ventilation, an electric fan mounted in the box 3 will be able to be linked to these ventilation holes.

According to another embodiment such as is shown in FIG. 4, the connectors 10a, 11a, 12a, and 13a are no longer attached to the separating wall 25, but are attached to the rear vertical side 22 of the reception station 2 and are located in the first compartment 2a.

With such an arrangement, the first compartment 2a no longer comprises the movable plate 241, and the bosses 242 are directly formed at least on the lower horizontal wall of the first compartment. The connectors 10b, 11b, 12b, and 13b that the box 3 comprises are mounted by attachment on a vertical wall 32a, forming a decoupling relative to the rear vertical wall 32 of said box 3. The connection between the connectors 10b, 11b, 12b, and 13b and 10a, 11a, 12a, and 13a is implemented by moving the box 3 in the first compartment 2a toward the rear side 22 of the reception station 2.

According to still another embodiment such as is shown in FIG. 5, the box 3 is inserted or removed from the first compartment 2a by pivoting around a vertical axis. To do this, the framework 30 of the box 3 comprises first hinge elements, and the separating partition 25, along its front edge, comprises second hinge elements designed to work by articulation with the first hinge elements.

According to this embodiment, the connectors of the reception station and the connectors of the box are attached to the end of the suitable electric cords. The connection is implemented manually.

Optionally, the connectors linked to the box 3 are mounted in a fixed manner relative to the latter, and the connectors linked to the reception station are mounted to be able to move. According to this embodiment, the separating wall 25 has through holes into which the connectors of the box are inserted when the latter is placed in the compartment 2a. These holes will be large enough to allow free passage of the connectors as well as the connection operation.

In order to lock the box 3 in position in its compartment 2a, there will be locks 29 that are each formed by a rocking lever and that can be arranged in an active position that prevents the movement of removal of the box 3, or in a removal position that allows this movement.

The electrical connectors 10a, 10b, 11a, 11b, 12a, 12b, 13a, and 13b that the reception stations 2 and box 3 comprise ensure electrical continuity between the electrical and electronic equipment internal to the box and the electrical and electronic networks and equipment external to the box that equip the premises.

These different connectors comprise the following:

high voltage supply connectors that ensure electrical supply of the assembly (phase and neutral, and ground), that ensures electrical supply of all of the recipients of the installation that equip the premises, for example, lamps, outlets, sirens, motors, valves, fans, etc.),

low voltage supply connectors, for example for a telephone, sensors 5 of the installation, as well as at least one communication bus, and the controls of the equipment,

connectors for optical transmissions.

To facilitate implementation of the wiring, there will be standardized connection signaling means of the matrix type affixed to at least one of the walls of the second compartment 2b or of the first, as required. To again facilitate this implementation, tool-less quick-wiring connectors will be able to be used at least with respect to the connectors linked to the reception station.

The electrical power supply networks will be divided into a power network and control network. They satisfy the following specifications:

for the power network, each function or each group of functions will be individually wired and their wiring will be of the point-to-point type, for example a lamp or a group of lamps will be supplied directly by the intelligent system.

The control and actuating networks will be able to be of several types, i.e., of the wire or wireless type with a bus-type or point-to-point-type topology.

for a wire-type control and actuating network, one wire part will comprise a sensor of the known type, for example a breaker that will support continuity in the electrical circuit either by a logic input in the form of a voltage or current value, or by an analog input.

for a wireless-type control network, data are transmitted by the transmitters and receivers linked to the intelligent system and the related equipment.

For a control network with a bus-type topology, the commands are transmitted digitally with a connection of different elements or peripherals to the bus.

The different commands or telecommands will be able to be implemented by pushbutton switches, keyboards or sensors. These commands are centralized on an input interface connected to the processing unit 6. The software programs implemented by the processing unit manage the state of different pieces of equipment via an output interface in order to authenticate the change of state from one linked power stage or to have an analog value vary, for example, for control of a smooth regulator.

An operating system in the degraded mode can ensure vital functions of the premises in the case of malfunction of a central apparatus of the system.

The unit 4 for protection of property and individuals is mounted in the box and comprises especially one or more electrical protective devices composed of differential switches or breakers as well as thermomagnetic breakers.

The equipment management processing unit 6 is likewise installed in the box 3. This processing unit 6 will be advantageously composed of standard equipment, for example a computer 60 provided with a display means 61, for example of the computer screen type, provided with at least one pointing means 62, for example, of the mouse or touch pad type, a card reader and a data input means 63 that can be composed of a touch pad, but also a keyboard or else an electroacoustic transducer of the microphone type for example, via which the processing unit 6 can receive voice commands, the latter unit then being equipped with a speech recognition module.

This processing unit 6 will be connected to interface devices between the electrical hardware of the premises such as, for example, switches, outlets, etc., and said processing unit 6, as well as interface devices with peripherals of the sensor or actuator type such as cameras, motors, electronic surveillance hardware, etc.

The processing unit 6 integrates programs described below for controlling various functions of the intelligent system.

A card reader 64 (magnetic or integrated circuit) can be linked to the processing unit 6, for example, in order to allow the user to identify himself and to pay on-line according to known techniques. With such a means, it is also possible to identify services as well as participants and to ensure management of services on-line. It is likewise possible, by way of this means, to store data in memory relative to the preferences of the occupant of the premises for purposes of safeguarding and transfer.

The system 1 according to the invention will be able to integrate a system for detection and warning of imminent danger such as a fire, gas leak, attempted breaking and entering, unauthorized presence, etc., managed by the processing unit 6. This detection system will be able to comprise one or more heat or infrared radiation sensors, one or more sensors of the presence of toxic gases in the atmosphere of the premises, and sensors of opening of devices that open and close, etc. This alarm and detection system will, moreover, comprise an acoustic and/or light device controlled by the processing unit 6 so as to warn of imminent danger. The acoustic device will be able to be composed of an electroacoustic transducer—for example of the speaker or siren type, installed either in the box 3 or at a distance from the latter. The light device will be able to be composed of an electric light activated by the processing unit 6.

The system 1 according to the invention will be able to be equipped with temperature sensors and light sensors. Based on the data supplied by these sensors 5, the processing unit 6 via dedicated interfaces will be able to control, for example, the opening or closing of devices that open and close on the premises, these devices potentially being electric shutters, electric curtains and/or electric awnings, as well as windows and other contrivances that open and close.

The information provided by the temperature sensor will be able to be used by the processing unit in order to control the heating and air conditioning means of the premises and to optimize energy management.

The intelligent system 1 according to the invention will likewise be able to be equipped with at least one camera in communication with the processing unit 6 that in combination with Internet access allows, for example, remote surveillance of the premises by the legal occupant and possibly surveillance of this legal occupant if he so authorizes. This arrangement is of interest since it allows the elderly or handicapped to be kept at home while enabling surveillance of the latter by authorized services.

The system according to the invention will ensure the following functions for keeping someone at home:

management of “leaving” and “arriving” scenarios,

remote assistance command to merchants (ex: supermarkets, baker, pharmacist, . . . ),

automatic and centralized closing of rolling shutters,

opening/closing of a gate and/or a barrier and/or a garage,

wake-up alarm (sounds or music),

link to the outside world (ex: Internet, telephone, cable, . . . ) with integrated router,

outside security management,

home security (presence, intrusion) recorder management,

domestic hazard management:
gas leak,
water leak,
carbon monoxide sensor
serious fall,

control and management of access to the home,

card reader for external services (housekeeper, nurses, and all others),

automated emergency calling (police, firefighters, security center, emergency medical service) as well as telephoning (land-line or mobile),

time management of service personnel assigned to an individual,

cardiac arrest sensors and in-home surveillance camera.

Moreover, the system will be able to ensure the following functions:

management, regulation and centralization of air conditioning and heating and optimization of power consumption.

management of interior life scenarios.

management of programmed supply of electric outlets (coffeepot, towel warmer . . . ).

awakening.

accessibility options (keyboard, sound, display), portal/hall video.

answering machine.

return call for visitors by land-line or mobile phone.

detection of breakdowns and/or failures on household appliances.

protection of electrical devices against lightning (sensitive hardware . . . ).

temperature increase of the freezer.

safe for valuables.

The system according to the invention will also be able to integrate control and management of means of broadcasting audiovisual programs or multimedia works.

Typically, these means are, for example, in a non-limiting way, a television, a video recorder medium reader, an audio recording medium reader, or speakers.

The software used by the processing unit 6 has two roles:

on the one hand, management of various control/command elements (acquisition, activation, communication by bus, for example), this management relating to hardware aspects, and

on the other hand, to offer to users access to different services, this aspect being essentially software-oriented.

With regard to software aspects, they can be divided into three categories:

1) the basic software of the system integrates management of the combination of the hardware, operating system and standard applications of the processing unit 6,

2) customization software of the intelligent system, depending on the topology of the premises and the range of operations. This is the level of the installer of the configuration and device maintenance, and

3) function management software that comprises access to system services, customization depending on the user's tastes. This is the level of the user and man-machine interface.

It is apparent that the term software encompasses a combination of software, the drivers of different hardware, the operating system and standard applications, office automation, and idle time.

The standard basic software comprises the following, for example:

the operating system of the processing unit 6,

the combination of hardware drivers installed in the device or interfacing with the computer 60, for example printer, modem card, Wifi (acronym for Wireless Fidelity) terminal, and input cards 8 and output cards 9,

the combination of standard application software necessary for use of integrated functions, for example web browser, e-mail and electronic organizer, and

the combination of standard application software chosen by the user, for example text processing, spreadsheet, and image processing.

The customization, installation configuration and system maintenance software makes it possible to configure the inputs/outputs depending on the sensors, cameras and devices that are to be controlled, effectively installed on the premises and according to the user's own choices.

The management software makes it possible to organize different lifestyle services of the occupants of the premises. It manages different user profiles that can be customized differently depending on their tastes, their deficiency, their age, their gender, for example for controlling the internal equipment in the box or installed in the premises depending on the user or users located there.

The system according to the invention will be able to comprise a collection of user type profiles that will make it possible to enliven the basic scenarios. An apprenticeship function can enrich these profiles by integrating customs of the users. Modification can be done in the form of options selected by the user or by automatic detection of repetitive behaviors. The user will have to authenticate the proposals thereof. The parameters can relate to hours of opening and closing, temperatures, subdued lighting, etc.

It goes without saying that this invention can accommodate all developments and variants in the area of technical equivalents without thereby departing from the framework of this patent.

1. Industrialized intelligent electrical system (1) that is designed to equip premises for example for use as a residence, said premises being equipped with an electric meter (C) and a general breaker (D), characterized in that it comprises:
a reception station (2) equipped with means of attachment to at least one wall of the premises,
a box (3) designed to be attached in a removable manner to the reception station (2),
a unit (4) for protection against electrical overloads and protection of property and individuals, installed in the box (3), on the one hand designed to be electrically connected to a breaker via an electrical line and by electrical connectors (10a) of the reception station (2) and (10b) of the box (3), and, on the other hand designed to be connected via working electrical connectors (11b) of the box (3), and (11a) of the reception station (2) to the electrical installation 1 of the premises,
at least one sensor (5) suitable for providing signals representative of physical quantities,
at least one processing unit (6) for equipment management, installed in the box (3), suitable for receiving, via working electrical connectors (12a) of the reception station (2) and (12b) of the box (3), electrical signals originating from each said sensor (5) and for controlling via working electrical connectors (13b) of the box (3) and (13a) of the reception station (2), depending on the signals provided by each said sensor (5), at least one electrical apparatus (7) installed in said premises.

2. System according to claim 1, wherein the reception station (2) comprises a first compartment (2a) designed to hold the box (3) in a removable manner and a second compartment (2a) adjoining the preceding allotted to the connecting wiring of the electrical, optical lines of the premises by means of electrical and/or optical connectors, said compartments being separated from one another by a partition (25).

3. System according to claim 2, wherein the connector or connectors (10a, 11a, 12a, 13a) of the reception station (2) and the connectors (10b, 11b, 12b, 13b) of the box (3) are movable.

4. System according to claim 2, wherein the connector or connectors (10a, 11a, 12a, 13a) of the reception station is or are attached to the separating wall (25).

5. System according to claim 4, wherein the connector or connectors (10b, 11b, 12b, 13b) of the box (3) is or are attached to one of the walls of the box (3).

6. System according to claim 4, wherein the connector or connectors (10b, 11b, 12b, 13b) of the box (3) is or are movable.

7. System according to claim 2, wherein the reception station (2) in the first compartment (2a) comprises means of positioning (242) and means of immobilization (28, 29) of the box (3), said box (3) comprising positioning means (340) designed to work by form-fitting with the positioning means (242) that the first compartment (2a) comprises.

8. System according to claim 1, wherein it comprises at least one means of communication to the outside.

9. System according to claim 1, wherein it comprises means of surveillance and maintenance of individuals at home.

10. System according to claim 1, wherein it comprises a means for detection and warning of imminent danger to the property and individuals, managed by the processing unit (6).

11. System according to claim 1, wherein it comprises a means of control of devices that open and close, managed by the processing unit (6).

12. System according to claim 1, wherein the processing unit (6) is adapted to implement at least one user profile for controlling at least one electrical apparatus (7) installed on the premises, depending on the user profile.

13. System according to claim 12, wherein the processing unit (6) is able to store the user profile on a removable medium.
